(19) United States
(12) Patent Application Publication
(10) Pub. No.: US 2024/0339659 A1
(43) Pub. Date: Oct. 10, 2024

(54) ADDITIVE FOR RECHARGEABLE LITHIUM BATTERY, ELECTROLYTE INCLUDING SAME AND RECHARGEABLE LITHIUM BATTERY

(71) Applicant: SAMSUNG SDI CO., LTD., Yongin-si (KR)

(72) Inventors: Bokyung RYU, Yongin-si (KR); Tae Jin LEE, Yongin-si (KR); Myungheui WOO, Yongin-si (KR); Hyejin PARK, Yongin-si (KR); Sang Hoon KIM, Yongin-si (KR); Hana RA, Yongin-si (KR)

(21) Appl. No.: 18/473,923

(22) Filed: Sep. 25, 2023

(30) Foreign Application Priority Data
Apr. 6, 2023 (KR) 10-2023-0045632

(51) Int. Cl. H01M 10/0567; H01M 10/0525; H01M 10/42

(52) U.S. Cl. CPC H01M 10/0567; H01M 10/0525; H01M 10/4235

(57) ABSTRACT

An additive for a rechargeable lithium battery, and an electrolyte for a rechargeable lithium battery and a rechargeable lithium battery including the same are provided. The additive includes a core including an aerogel, and a shell around (e.g., surrounding) the core, wherein the shell includes a polymer having a melting point of about 90 to about 120° C.

### CROSS-REFERENCE TO RELATED APPLICATION

The present application claims priority to and the benefit of Korean Patent Application No. 10-2023-0045632, filed on Apr. 6, 2023, in the Korean Intellectual Property Office, the entire content of which is hereby incorporated by reference.

### BACKGROUND

### 1. Field

Embodiments of the present disclosure relate to an additive for a rechargeable lithium battery, an electrolyte for a rechargeable lithium battery and/or a rechargeable lithium battery.

### 2. Description of the Related Art

Rechargeable lithium batteries may be recharged and have three or more times the energy density per unit weight as comparable lead storage batteries, nickel-cadmium batteries, nickel hydrogen batteries, nickel zinc batteries, and/or the like. Rechargeable lithium batteries may be also charged at relatively high rates and thus they are commercially manufactured for laptops, cell phones, electric tools, electric bikes, and/or the like, and research on improving energy densities have been actively made and/or pursued.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

For example, an electrolyte includes an organic solvent in which a lithium salt is dissolved and may critically determine stability and performance of a rechargeable lithium battery.

LiPF₆, which is commonly utilized as a lithium salt of an electrolyte, has a problem of reacting with an organic solvent of an electrolyte, causing depletion of the solvent and generating a relatively large amount of gas. If (e.g., when) LiPF₆ is decomposed, it generates LiF and PF₅, which leads to electrolyte depletion in the battery, resulting in degradation in high temperature performance and possibly poor safety.

Accordingly, an electrolyte with improved safety without or with reduced deterioration in performance even under high temperature conditions is desired and/or needed.

### SUMMARY

Aspects of one or more embodiments of the present disclosure are directed toward an additive for a rechargeable lithium battery with improved thermal stability.

Aspects of one or more embodiments of the present disclosure are directed toward an electrolyte for a rechargeable lithium battery having improved cycle-life characteristics and with relatively high-temperature safety and/or high-temperature reliability by applying the additive.

Aspects of one or more embodiments of the present disclosure are directed toward a rechargeable lithium battery including the electrolyte.

Additional aspects will be set forth in part in the description which follows and, in part, will be apparent from the description, or may be learned by practice of the presented embodiments of the disclosure.

An additive for a rechargeable lithium battery according to one or more embodiments of the present disclosure includes a core including an aerogel and a shell around (e.g., surrounding) the core, wherein the shell includes a polymer having a melting point of about 90 to about 120° C.

In one or more embodiments, a thickness ratio of the core to the shell may be about 1:1 to about 4:1.

In one or more embodiments, the core may have a thickness of about 0.1 um to about 2.0 μm, and the shell may have a thickness of about 0.025 μm to about 0.5 μm.

In one or more embodiments, the core may have a density of about 0.002 g/cm³ to about 0.03 g/cm³.

In one or more embodiments, he aerogel may be an inorganic oxide aerogel, a carbon aerogel, or a combination thereof.

In one or more embodiments, he aerogel may have a monolithic, block, sheet, powder, fiber, or granular shape. In one or more embodiments, he polymer may include

poly (vinylidenefluoride-hexafluoropropylene) (PVDF-HFP), polyacrylic acid, polyethylene, poly (methyl methacrylate), poly (alkylene oxide), poly (alkylene succinate), or a combination thereof.

In one or more embodiments, he additive may be in a form of a fiber (e.g, a fiber formed utilizing electrospinning).

In one or more embodiments, he additive may have an ionic conductivity of about 1.0×10⁻⁴ S·cm⁻¹ to about 1.0×10⁻² S·cm⁻¹.

According to one or more embodiments of the present disclosure, an electrolyte for a rechargeable lithium battery includes a non-aqueous organic solvent, a lithium salt, and the aforementioned additive for a rechargeable lithium battery.

In one or more embodiments, he additive for a rechargeable lithium battery may be included in an amount of about 0.1 wt % to about 20 wt %, about 0.1 wt % to about 15 wt %, or about 0.1 wt % to about 10 wt % based on a total weight of the electrolyte for the rechargeable lithium battery.

According to one or more embodiments of the present disclosure, a rechargeable lithium battery includes a positive electrode including a positive electrode active material; a negative electrode including a negative electrode active material; and the aforementioned electrolyte.

The additive for a rechargeable lithium battery according to one or more embodiments has excellent or suitable electrolyte impregnability and can maintain battery characteristics without increasing battery resistance when applied to the electrolyte.

In one or more embodiments, in the rechargeable lithium battery including the additive for a rechargeable lithium battery according to one or more embodiments, ignition of the battery is controlled or selected at a temperature higher than a battery operating temperature, and safety of the battery may be improved.

### BRIEF DESCRIPTION OF THE DRAWINGS

FIG. 1 is a cross-sectional view of an additive according to one or more embodiments of the present disclosure.

FIG. 2 is a schematic view illustrating a rechargeable lithium battery according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

The illustrated embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

In the drawings, the thickness of layers, films, panels, regions, etc., may be exaggerated for clarity.

It will be understood that when an element, such as a layer, film, region, or substrate, is referred to as being “on” of “connected to” another element, it may be directly on or connected to the other element or one or more intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

Unless otherwise apparent from the context, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

Hereinafter, “combination” includes mixtures of two or more, mutual substitution, and/or layered structures of two or more.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

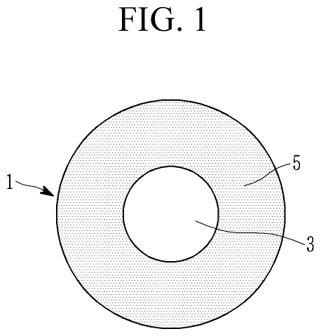

Hereinafter, an additive for a rechargeable lithium battery according to one or more embodiments will be described with reference to FIG. 1.

FIG. 1 is a cross-sectional view of an additive according to one or more embodiments of the present disclosure.

Referring to FIG. 1, an additive 1 according to one or more embodiments

includes a core 3 and a shell 5 around (e.g., surrounding) the core 3. The core 3 includes an aerogel, and the shell 5 includes a polymer having a melting point of about 90 to about 120° C.

Because the additive 1 has a structure including the core 3 and the shell 5, battery characteristics may be maintained without increasing the resistance of the battery compared to the case where the core material is introduced into the battery as it is. In one or more embodiments, because the core 3 includes an aerogel, when the shell 5 of the additive is melted at a high temperature, the core material is released from the core 3 to the outside, reducing the thermal conductivity of the battery and controlling or reducing ignition of the battery.

A thickness ratio of the core 3 to the shell 5 may be about 1:1 to about 4:1, for example about 3:2, for example about 2:1, for example, about 5:2, and for example, about 3:1, but the present disclosure is not limited thereto.

When the thickness ratio of the core 3 and the shell 5 is within the above range(s), the melting of the shell 5 and the release of the core material can be adjusted within an appropriate or suitable range, and the occurrence of an electrode short circuit can be effectively controlled or reduced in a high-temperature state. In one or more embodiments, in the case that it is not a high temperature, the shell 5 is not easily damaged, thereby preventing or reducing unnecessarily increasing battery resistance and deteriorating battery characteristics.

If (e.g., when) the additive including the core 3 and the shell 5 is in the form of a fiber, the “thickness of the core” refers to a straight line length of a line segment from the center of a circle, which is a fiber cross-section, to a point on the circumference of the core, and “thickness of the shell” refers to a straight line length between a point where a line segment meets the circumference of the core and a point where it meets the circumference of the shell when a line segment from the center of the circle, which is the cross section of the fiber, to a point on the circumference of the shell, is connected.

When the additive including the core 3 and the shell 5 has a spherical shape, the “thickness of the core” refers to a length of a line segment (e.g., a radius) from the center of the sphere to a point on the surface (e.g., the outermost surface) of the core, and the “thickness of the shell” refers to a length between a point where a line segment meets the surface of the core and a point where it meets the surface (e.g., outermost surface) of the shell when a line segment from the center of the sphere to a point on the surface of the shell is connected.

The core 3 may have a thickness of about 0.1 μm to about 2.0 μm, for example, greater than or equal to about 0.1 μm, greater than or equal to about 0.15 μm, greater than or equal to about 0.20 μm, greater than or equal to about 0.25 μm, greater than or equal to about 0.30 μm, or greater than or equal to about 0.35 μm, and less than or equal to about 2.0 μm, for example, less than or equal to about 1.5 μm, less than or equal to about 1.4 μm, less than or equal to about 1.3 μm, less than or equal to about 1.2 μm, less than or equal to about 1.1 μm, or less than or equal to about 1.0 μm, but the present disclosure is not limited thereto.

If (e.g., when) the core 3 has a thickness within the above range(s), battery characteristics can be maintained without deteriorating electrolyte impregnability and without unnecessarily increasing battery resistance, along with the melting of the shell in an appropriate or suitable time to prevent or reduce ignition.

The core 3 may have a density (i.e., a core density of the additive) of about 0.002 g/cm³ to about 0.01 g/cm³, for example, greater than or equal to about 0.002 g/cm³, greater than or equal to about 0.003 g/cm³, greater than or equal to about 0.004 g/cm³, or greater than or equal to about 0.005 g/cm³, and less than or equal to about 0.03 g/cm³, less than or equal to about 0.025 g/cm³, less than or equal to about 0.020 g/cm³, less than or equal to about 0.015 g/cm³, less than or equal to about 0.010 g/cm³, less than or equal to about 0.009 g/cm³, or less than or equal to about 0.08 g/cm³, but the present disclosure is not limited thereto.

If (e.g., when) the core 3 has a density within at least one of the above range(s), the additive 1 according to one or more embodiments may be evenly dissolved in the electrolyte, and battery ignition may be effectively controlled or reduced after the core material is released at a high temperature.

The core 3 may include an aerogel, and because the aerogel has excellent or suitable heat resistance, when released from the core at a high temperature, thermal conductivity may be drastically lowered, and battery ignition may be effectively controlled or suppressed, thereby improving battery stability.

The aerogel may include an inorganic oxide aerogel, a carbon aerogel, or a combination thereof.

The inorganic oxide aerogel may include silica aerogel, alumina aerogel, titania aerogel, zirconia aerogel, and/or the like.

The aerogel may have a monolithic, block, sheet, powder, fiber, or granular shape, but the present disclosure is not limited thereto.

The aerogel may have a surface area of about 100 m²/g to about 1,000 m²/g. For example, the surface area may be greater than or equal to about 100 m²/g, greater than or equal to about 150 m²/g, greater than or equal to about 200 m²/g, greater than or equal to about 250 m²/g, greater than or equal to about 300 m²/g, greater than or equal to about 400 m²/g, greater than or equal to about 500 m²/g, less than or equal to about and 1,000 m²/g, and less than or equal to about 950 m²/g, less than or equal to about 900 m²/g, less than or equal to about 850 m²/g, less than or equal to about 800 m²/g, less than or equal to about 700 m²/g, or less than or equal to about 600 m²/g. The surface area of the aerogel is not particularly limited, and may have a surface area of commercially available aerogels.

The aerogel may have a pore size of about 1 nm to about 20 nm. For example, it may be greater than or equal to about 1 nm, greater than or equal to about 3 nm, greater than or equal to about 5 nm, greater than or equal to about 7 nm, or greater than or equal to about 10 nm, and less than or equal to about 20 nm, less than or equal to about 18 nm, less than or equal to about 16 nm, or less than or equal to about 14 nm. The pore size of the aerogel is not particularly limited, and may have a pore size of a commercially available aerogel.

The aerogel may be hydrophobically surface-treated. The hydrophobic surface-treated aerogel may be an aerogel substituted with a hydrophobic functional group. The hydrophobic functional group may be a C1 to C6 alkyl group, and specifically may be a methyl group, an ethyl group, a propyl group, a butyl group, a pentyl group, or a combination thereof.

The shell 5 may have a thickness of about 0.025 μm to about 0.5 μm, for example, greater than or equal to about 0.025 μm, greater than or equal to about 0.05 μm, greater than or equal to about 0.075 μm, greater than or equal to about 0.10 μm, greater than or equal to about 0.125 μm, or greater than or equal to about 0.15 μm, and less than or equal to about 0.5 μm, for example, less than or equal to about 0.45 μm, less than or equal to about 0.40 μm, less than or equal to about 0.35 μm, or less than or equal to about 0.30 μm, but the present disclosure is not limited thereto.

If (e.g., when) the shell 5 has a thickness within the above range(s), ignition of the battery can be effectively controlled or suppressed by melting the shell 5 and releasing the core material in an appropriate or suitable time, and battery characteristics can be maintained by not unnecessarily increasing battery resistance.

In one or more embodiments, the shell 5 may be a polymer having a melting point of about 90 to about 120° C., and for example, the polymer may be a thermoplastic resin. These polymers have excellent or suitable ionic conductivity and can be melted at a specific temperature while remaining stable in an operating temperature range of the battery, thereby contributing to the safety of the battery. In one or more embodiments, the polymer included in the shell 5 can improve wettability of an electrolyte.

For example, the thermoplastic resin may be poly (vinylidene fluoride-hexafluoropropylene) (PVDF-HFP), polyacrylic acid, polyethylene, poly (methyl methacrylate), poly (alkylene oxide), poly (alkylene succinate), or a combination thereof, for example, poly (vinylidene fluoride-hexafluoropropylene) (PVDF-HFP), polyalkylene oxide, poly (alkylene succinate), or a combination thereof, but the present disclosure is not limited thereto.

The polyalkylene oxide may be polyethylene oxide, polypropylene oxide, polybutylene oxide, polypentylene oxide, polyhexylene oxide, polyheptylene oxide, and/or the like., for example, polyethylene oxide, polypropylene oxide, or polybutylene. oxide, and/or the like, for example, polyethylene oxide, polypropylene oxide, and/or the like, but the present disclosure is not limited thereto.

The polyalkylene succinate may be polyethylene succinate, polypropylene succinate, polybutylene succinate, polypentylene succinate, polyhexylene succinate, polyheptylene succinate, polyoxylene succinate, and/or the like, for example, polyethylene succinate, polypropylene succinate, or polybutylene succinate, for example, polybutylene succinate, and/or the like, but the present disclosure is not limited thereto.

The polymer included in the shell 5 may have a melting point of about 90 to about 120° C., for example, greater than or equal to about 90° C., greater than or equal to about 92° C., greater than or equal to about 94° C., greater than or equal to about 97° C., greater than or equal to about 100° C., and less than or equal to about 120° C., less than or equal to about 117° C., less than or equal to about 115° C., less than or equal to about 113° C., or less than or equal to about 110° C., but the present disclosure is not limited thereto.

Because the melting point of the polymer included in the shell 5 has the above range (s, the shell 5 is stably maintained in an operating temperature range during charging and discharging of the battery, so that the resistance of the battery may not increase and the shell 5 at a high temperature of about 100° C. or higher may be appropriately melted, and the aerogel of the core 3 is released in an appropriate or suitable time to effectively control or reduce ignition of the battery.

The additive 1 may be in the form of a fiber formed by electrospinning, that is, in the form of a fiber. If (e.g., when) the additive is in the form of a fiber, the core material is effectively eluted at a high temperature, thereby effectively controlling or reducing ignition of the battery. In addition to the form of a fiber, if (e.g., when) it can have a structure including a core 3 and a shell 5 around (e.g., surrounding) it, and the additive 1 may have an irregular, plate-like, or spherical form, but the present disclosure is not limited thereto.

When preparing the core-shell structured additive 1, the electrospinning process may be performed by a generally available or suitable process in consideration of melting temperatures of aerogel and thermoplastic resin.

The ionic conductivity of the additive 1 may be about 1.0×10⁻⁴ S·cm⁻¹ to about 1.0×10⁻² S·cm⁻¹. For example, it may be greater than or equal to about 1.0×10⁻⁴ S·cm⁻¹, greater than or equal to about 3.0×10⁻⁴ S·cm⁻¹, greater than or equal to about 5.0×10⁻⁴ S·cm⁻¹, greater than or equal to about 7.0×10⁻⁴ S·cm⁻¹, greater than or equal to about 9.0×10⁻⁴ S·cm⁻¹, or greater than or equal to about 1.0×10⁻³ S·cm⁻¹, and less than or equal to about 1.0×10⁻² S·cm⁻¹, for example less than or equal to about 0.9×10⁻² S·cm⁻¹, less than or equal to about 0.7×10⁻² S·cm⁻¹, less than or equal to about 0.5×10⁻² S·cm⁻¹, or less than or equal to about 0.3×10⁻² S·cm⁻¹, but the present disclosure is not limited thereto.

If (e.g., when) the ionic conductivity of the additive 1 is within the above range(s), battery characteristics may be maintained without increasing battery resistance when applied to the electrolyte according to one or more embodiments.

The additive 1 may be included in an amount of about 0.1 wt % to about 20 wt %, about 0.1 wt % to about 15 wt %, or about 0.1 wt % to about 10 wt % based on a total weight of the electrolyte. For example, the additive may be included in an amount of greater than or equal to about 0.1 wt %, for example, greater than or equal to about 0.2 wt %, greater than or equal to about 0.3 wt %, greater than or equal to about 0.4 wt %, greater than or equal to about 0.5 wt %, greater than or equal to about 0.6 wt %, greater than or equal to about 0.7 wt %, greater than or equal to about 0.8 wt %, greater than or equal to about 0.9 wt %, or greater than or equal to about 1 wt % and less than or equal to about 15.0 wt %, for example, less than or equal to about 14.0 wt %, less than or equal to about 13.0 wt %, less than or equal to about 12.0 wt %, less than or equal to about 11.0 wt %, less than or equal to about 10.0 wt %, or less than or equal to about 9.0 wt % based on a total weight of the electrolyte for a rechargeable lithium battery, but the present disclosure is not limited thereto.

If (e.g., when) the content (e.g., amount) of the additive 1 is within the above range(s), a rechargeable lithium battery having improved safety can be implemented by maintaining battery characteristics without increasing battery resistance at a battery operating temperature and increasing battery resistance at a temperature exceeding the battery operating temperature.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may be methyl acetate, ethyl acetate, n-propyl acetate, t-butyl acetate, methylpropionate, ethylpropionate, propylpropionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. In one or more embodiments, the ketone-based solvent may be cyclohexanone, and/or the like. In one or more embodiments, the alcohol-based solvent may be ethyl alcohol, isopropyl alcohol, and/or the like and the aprotic solvent may be a nitrile or nitriles such as R—CN, which may include a C2 to C20 linear, branched, or cyclic hydrocarbon group and may include a double bond, aromatic ring, or an ether bond, an amide or amides such as dimethylformamide, dioxolanes such as 1,3-dioxolane, sulfolanes, and/or the like.

The non-aqueous organic solvent may be utilized alone or in a mixture, if (e.g., when) the organic solvent is utilized in a mixture, the mixture ratio may be controlled or selected in accordance with a desirable battery performance.

The carbonate-based solvent may be prepared by mixing a cyclic carbonate and a linear carbonate. In this case, when the cyclic carbonate and the chain carbonate are mixed in a volume ratio of 1:1 to 1:9, the performance of the electrolyte may be improved.

The non-aqueous organic solvent may further include an aromatic hydrocarbon-based organic solvent in the carbonate-based solvent. In this case, the carbonate-based solvent and the aromatic hydrocarbon-based solvent may be mixed in a volume ratio of 1:1 to 30:1.

As the aromatic hydrocarbon-based solvent, an aromatic hydrocarbon-based compound represented by Chemical Formula 1 may be utilized.

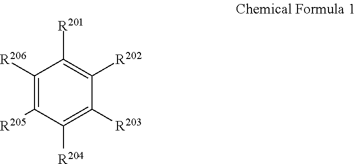

In Chemical Formula 1, R²⁰¹ to R²⁰⁶ may each independently be the same or different and may be (e.g., may be selected from) hydrogen, a halogen, a C1 to C10 alkyl group, a C1 to C10 haloalkyl group, and/or a combination thereof.

Specific examples of the aromatic hydrocarbon-based solvent may be (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

In order to improve cycle-life characteristics of the battery, the electrolyte may further include vinylene carbonate, vinyl ethylene carbonate, or an ethylene-based carbonate-based compound represented by Chemical Formula 2 as a cycle-life improving additive in order to improve battery cycle-life characteristics.

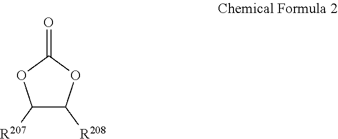

In Chemical Formula 2, R²⁰⁷ and R²⁰⁸ may each independently be the same or different, and hydrogen, a halogen, a cyano group (CN), a nitro group (NO₂), or a fluorinated C1 to C5 alkyl group.

Examples of the ethylene carbonate-based compound may be difluoroethylene carbonate, chloroethylene carbonate, dichloroethylene carbonate, bromoethylene carbonate, dibromoethylene carbonate, nitroethylene carbonate, cyanoethylene carbonate or fluoroethylene carbonate. The amount of the additive for improving cycle-life characteristics may be utilized within an appropriate or suitable range.

The lithium salt is dissolved in the non-aqueous organic solvent, and supplies a battery with lithium ions, basically operates the rechargeable lithium battery, and improves transportation of the lithium ions between positive and negative electrodes.

Examples of the lithium salt include one or more of (e.g., one or more selected from) LiPF₆, LiBF₄, LiDFOP, LiDFOB, LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, for example an integer of 1 to 20, LiCl, Lil, and/or LiB(C₂O₄)₂ (lithium bis (oxalato) borate: LiBOB). The lithium salt may be utilized in a concentration in a range of 0.1 M to 2.0 M. If (e.g., when) the lithium salt is included at the above concentration range, an electrolyte may have excellent or suitable performance and lithium ion mobility due to optimal or suitable electrolyte conductivity and viscosity.

The additive and the electrolyte may be applied to a rechargeable lithium battery.

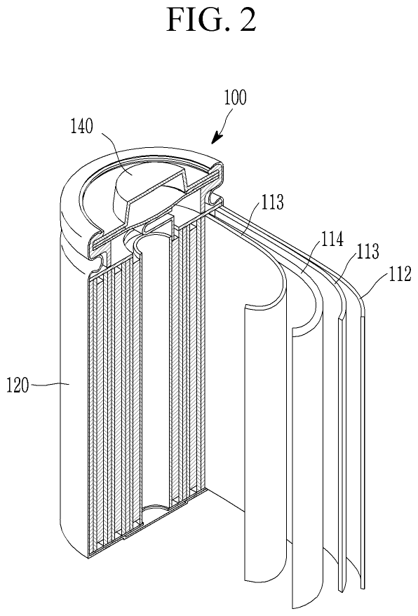

Hereinafter, a rechargeable lithium battery according to one or more embodiments will be described with reference to FIG. 2.

A rechargeable lithium battery 100 according to one or more embodiments includes a positive electrode 114 including a positive electrode active material; a negative electrode 112 including a negative electrode active material; and the aforementioned electrolyte.

A rechargeable lithium battery may be classified into a lithium ion battery, a lithium ion polymer battery, where the lithium polymer battery depends on the kind of separator and electrolyte used. It also may be classified to be cylindrical, prismatic, coin-type or kind, pouch-type or kind, and/or the like depending on the shape. In one or more embodiments, it may be a bulk type or kind or a thin film type or kind, depending on the size. Suitable structures and manufacturing methods for lithium ion batteries pertaining to this disclosure are generally available in the art.

Herein, as an example of the rechargeable lithium battery, a cylindrical rechargeable lithium battery will be described in more detail. FIG. 2 schematically illustrates the structure of a rechargeable lithium battery according to one or more embodiments. Referring to FIG. 2, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte impregnating the positive electrode 114, the negative electrode 112, and the separator 113, a battery case 120 housing the battery cell, and a sealing member 140 sealing the battery case 120. The positive electrode 114 includes a positive electrode current collector and a positive electrode active material layer on the positive electrode current collector, and the positive electrode active material layer includes a positive electrode active material.

The positive electrode active material may include lithiated intercalation compound(s) that reversibly intercalate and deintercalate lithium ions. For example, at least one of a composite oxide of a metal containing cobalt, manganese, nickel or a combination thereof and lithium may be utilized.

A part of the metal of the composite oxide may be substituted with a metal other than the other metal, and may be at least one of (e.g., at least one selected from) phosphoric acid compounds of the complex oxide, such as LiFePO₄, LiCoPO₄, and/or LiMnPO₄. A composite oxide having a coating layer on the surface may be utilized, or a mixture of the composite oxide and the composite oxide having a coating layer may be utilized. The coating layer may include at least one coating element compound of (e.g., at least one coating element compound selected from) an oxide of a coating element, a hydroxide of a coating element, an oxyhydroxide of a coating element, an oxycarbonate of a coating element, and/or a hydroxy carbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any generally available processes as long as it does not cause any side effects on the properties of the positive electrode active material (e.g., spray coating or dipping), which may be well understood by those engaged in the relevant field and thus a detailed description may not be provided.

The positive electrode active material may be, for example, at least one of the lithium composite oxides represented by Chemical Formula 3.

LiₓM¹_{y}M²_{z}M³_{1-y-z}O₂ Chemical Formula 3

In Chemical Formula 3,

0.5≤x≤1.8, 0<y≤1, 0≤z≤1, 0≤y+z≤1, and M¹, M², and M³ may each independently be (e.g., may each independently be selected from) metals of Ni, Co, Mn, Al, Sr, Mg or La, and/or the like, and/or a combination thereof.

In one or more embodiments, the positive electrode active material may be at least one of (e.g., at least one selected from) LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and/or LiNiₑCo_{f}Al_{g}O₂ (e+f+g=1).

For example, the positive electrode active material of (e.g., selected from) LiNiₐMn_{b}Co_{c}O₂ (a+b+c=1), LiNiₐMn_{b}Co_{c}AlO₂ (a+b+c+d=1), and/or LiNiₑCo_{f}Al_{g}O₂ (e+f+g=1) may be a high Ni-based positive electrode active material.

For example, in the case of LiNiₐMn_{b}Co_{c}O₂ (a+b+c=1) and LiNiₐMn_{b}Co_{c}Al_{d}O₂ (a+b+c+d=1), the nickel content (e.g., amount) may be greater than or equal to about 60% (a≥0.6), and more specifically, greater than or equal to about 80% (a≥0.8).

For example, in the case of LiNiₑCo_{f}Al_{g}O₂ (e+f+g=1), the nickel content (e.g., amount) may be greater than or equal to about 60% (e≥0.6), and more specifically, greater than or equal to about 80% (e≥0.8).

The content (e.g., amount) of the positive electrode active material may be 90 wt % to 98 wt % based on the total weight of the positive electrode active material layer.

The positive electrode active material layer may optionally include a conductive material and a binder. In such cases, the content (e.g., amount) of each of the conductive material and the binder may be about 1.0 wt % to about 5.0 wt %, based on a total weight of the positive electrode active material layer.

The conductive material is included to impart conductivity to the positive electrode and any suitable electrically conductive material may be utilized as a conductive material unless it causes a chemical change. Examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum silver, and/or the like; a conductive polymer such as a polyphenylene derivative; or a mixture thereof.

The binder improves binding properties of positive electrode active material particles with one another and with a current collector. Examples thereof may for example include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The positive electrode current collector may include Al (aluminum), but the present disclosure is not limited thereto.

The negative electrode includes a negative electrode current collector and a negative electrode active material layer including the negative electrode active material formed on the negative electrode current collector.

The negative electrode active material includes a material capable of reversibly intercalating/deintercalating lithium ions, lithium metal, a lithium metal alloy, a material capable of doping and undoping lithium, or a transition metal oxide.

The material that reversibly intercalates/deintercalates lithium ions includes carbon materials and the carbon material may be any generally-utilized carbon-based negative electrode active material in a rechargeable lithium battery and examples of the carbon material include crystalline carbon, amorphous carbon, and/or a combination thereof. The crystalline carbon may be non-shaped, or sheet, flake, spherical, or fiber shaped natural graphite or artificial graphite and the amorphous carbon may be a soft carbon, a hard carbon, a mesophase pitch carbonized product, calcined coke, and/or the like.

The lithium metal alloy may include lithium and a metal of (e.g., a metal selected from) Na, K, Rb, Cs, Fr, Be, Mg, Ca, Sr, Si, Sb, Pb, In, Zn, Ba, Ra, Ge, Al, and/or Sn.

The material capable of doping and dedoping lithium may include Si, SiOₓ (0<x<2), a Si—Q alloy (wherein Q is (e.g., is selected from) an alkali metal, an alkaline-earth metal, a Group 13 element, a Group 14 element, a Group 15 element, a Group 16 element, a transition metal, a rare earth element, and/or a combination thereof, and not Si), Sn, SnO₂, a Sn—R alloy (wherein R is an alkali metal, an alkaline-earth metal, a Group 13 element, a Group 14 element, a Group 15 element, a Group 16 element, a transition element, a rare earth element, or a combination thereof, and not Sn), and/or the like, and at least one of them may be mixed with SiO₂.

The elements Q and R may be (e.g., may be selected from) Mg, Ca, Sr, Ba,

Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or combination thereof.

The transition metal oxide may be a vanadium oxide, a lithium vanadium oxide, and/or the like.

In one or more embodiments, the negative electrode active material may be a Si—C composite including a Si-based active material and a carbon-based active material.

In the Si—C composite, the Si-based active material may have an average particle diameter of 50 nm to 200 nm. When the Si-based active material has an average particle diameter within this range, the volume expansion occurring during the charge and discharge may be suppressed or reduced, and disconnection of conductive paths by particles crushed during the charge and discharge may be prevented or reduced.

The Si-based active material may be included in an amount of 1 wt % to 60 wt %, or for example, 3 wt % to 60 wt % based on the total weight of the Si—C composite.

According to one or more embodiments, the negative electrode active material may further include crystalline carbon along with the aforementioned Si—C composite.

When the negative electrode active material includes the Si—C composite and the crystalline carbon together, the Si—C composite and the crystalline carbon may be included in the form of a mixture, and in this case, the Si—C composite and the crystalline carbon may be included in a weight ratio of about 1:99 to about 50:50. More specifically, the Si—C composite and the crystalline carbon may be included in a weight ratio of about 5:95 to about 20:80.

The crystalline carbon may include, for example, graphite, and, for example, natural graphite, artificial graphite, or a mixture thereof.

An average particle diameter of the crystalline carbon may be 5 μm to 30 μm.

In the present disclosure, an average particle diameter may be particle size (D₅₀) at a volume ratio of 50—% in a cumulative size-distribution curve.

The Si—C composite may further include a shell around (e.g., surrounding) the surface of the Si—C composite, and the shell may include amorphous carbon. The amorphous carbon may include soft carbon, hard carbon, a mesophase pitch carbonized product, calcined coke, or a mixture thereof.

The amorphous carbon may be included in an amount of about 1 to about 50 parts by weight, for example, about 5 to about 50 parts by weight, or about 10 to about 50 parts by weight based on 100 parts by weight of the carbon-based active material.

In the negative electrode active material layer, the negative electrode active material may be included in an amount of about 95 wt % to about 99 wt % based on the total weight of the negative electrode active material layer.

In one or more embodiments, the negative electrode active material layer may include a binder, and optionally a conductive material. In the negative electrode active material layer, the amount of the binder may be about 1 wt % to about 5 wt % based on the total weight of the negative electrode active material layer. If (e.g., when) the conductive material is further included, negative electrode active material layer may include about 90 wt % to about 98 wt % of the negative electrode active material, about 1 wt % to about 5 wt % of the binder, and about 1 wt % to about 5 wt % of the conductive material.

The binder improves binding properties of negative electrode active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be (e.g., may be selected from) a styrene-butadiene rubber, an acrylated styrene-butadiene rubber (SBR), an acrylonitrile-butadiene rubber, an acrylic rubber, a butyl rubber, a fluorine rubber, and/or a combination thereof. The polymer resin binder may be (e.g., may be selected from) polytetrafluoroethylene, an ethylenepropylene copolymer, polyethyleneoxide, polyvinylpyrrolidone, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, and/or a combination thereof.

When the water-soluble binder is utilized as the negative electrode binder, a cellulose-based compound may be further utilized as a thickener to provide viscosity. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of about 0.1 to about 3 parts by weight based on 100 parts by weight of the negative electrode active material.

The conductive material is included to provide electrode conductivity and any electrically conductive material may be utilized as a conductive material unless it causes a chemical change, and examples thereof may be a carbon-based material such as natural graphite, artificial graphite, carbon black, acetylene black, ketjen black, a carbon fiber and/or the like; a metal-based material such as a metal powder or a metal fiber and/or the like of copper, nickel, aluminum, silver, and/or the like; a conductive polymer such as a polyphenylene derivative and/or the like, or a mixture thereof.

The negative electrode current collector may be (e.g., may be selected from) a copper foil, a nickel foil, a stainless steel foil, a titanium foil, a nickel foam, a copper foam, a polymer substrate coated with a conductive metal, and/or a combination thereof.

A separator may be present between the positive electrode and the negative electrode depending on a type or kind of the rechargeable lithium battery. The separator may be a porous substrate; or a composite porous substrate.

The porous substrate is a substrate including pores, through which lithium ions can move. The porous substrate may include polyethylene, polypropylene, polyvinylidene fluoride, or a multilayer film of two or more layers thereof such as a polyethylene/polypropylene double-layered separator, a polyethylene/polypropylene/polyethylene triple-layered separator, and/or a polypropylene/polyethylene/polypropylene triple-layered separator.

The composite porous substrate may have a form including a porous substrate and a functional layer on the porous substrate. The functional layer may be, for example, at least one of a heat-resistant layer and/or an adhesive layer from the viewpoint of enabling additional function. For example, the heat-resistant layer may include a heat-resistant resin and optionally a filler. In one or more embodiments, the adhesive layer may include an adhesive resin and optionally a filler. The filler may be an organic filler or an inorganic filler.

The additive for a rechargeable lithium battery according to one or more embodiments may be included in the electrolyte as described above, and may be applied to a current collector, an electrode tab, a separator, and/or the like of a rechargeable lithium battery.

When the additive is applied to a current collector or an electrode tab, a coating solution in which the additive is dispersed in an appropriate or suitable solvent may be coated on the uncoated portion of the current collector or the electrode tab. in case that the additive is applied to the separator, at least one surface of the separator may be coated with a coating solution obtained by including the additive in a separator component or dispersing the additive in an appropriate or suitable solvent.

Hereinafter, the present disclosure is illustrated in more detail with reference to examples. However, these examples are for purposes of illustration, and the present disclosure is not limited thereto.

### Synthesis of Additives

### Synthesis Example 1

An additive in the form of a fiber was prepared by preparing a solution in which 1 wt % of aerogel was dispersed in a polyacrylonitrile solvent and a polymer solution including 10 wt % of poly (vinylidenefluoride hexafluoropropylene) (PVDF-HFP, melting point: 110° C.), and then, electrospinning (applying 15 kV, setting a distance from an elecrospinning needle to ground to be 10 cm) was performed to have a thickness ratio of 1:1 between a core and a shell.

### Synthesis Example 2

An additive in the form of a fiber was prepared by preparing a solution in which 2 wt % of aerogel was dispersed in a polyacrylonitrile solvent and a polymer solution including 10 wt % of poly (vinylidenefluoride hexafluoropropylene) (PVDF-HFP, melting point: 110° C.), and then electrospinning them to have a thickness ratio of 2:1 between a core and a shell.

### Synthesis Example 3

An additive in the form of a fiber was prepared by preparing a solution in which 4 wt % of aerogel was dispersed in a polyacrylonitrile solvent and a polymer solution including 10 wt % of poly (vinylidenefluoride hexafluoropropylene) (PVDF-HFP, melting point: 110° C.), and then electrospinning them to have a thickness ratio of 4:1 between a core and a shell.

### Comparative Synthesis Example 1

An additive in the form of a fiber was prepared in substantially the same manner as in Synthesis Example 1 except that the polymer solution was prepared to include polyethylene glycol (PEG, melting point: 50° C.) instead of the poly (vinylidenefluoride-hexafluoropropylene) (PVDF-HFP).

### Manufacture of Rechargeable Lithium Battery Cells

### Example 1

A rechargeable lithium battery cell was manufactured by utilizing LiCoO₂ as a positive electrode, artificial graphite as a negative electrode, and an electrolyte having the following composition:

### Composition of Electrolyte

Salt: 1.3 M LiPF₆

Non-aqueous organic solvent: ethylene carbonate (EC): propylene carbonate (PC): ethyl propionate (EP): propyl propionate (PP)=15:15:25:45 (a volume ratio)

Additive: 3 wt % of fluoroethylene carbonate, 1 wt % of SN (succinonitrile), 10 wt % of the additive according to Synthesis Example 1

(However, in composition of the electrolyte, “wt %” refers to a relative content (e.g., amount) of the additives based on 100% weight of the total electrolyte (lithium salt+non-aqueous organic solvent+additive)).

### Comparative Example 1

A rechargeable lithium battery cell was manufactured in substantially the same manner as in Example 1 except that the additive of Comparative Synthesis Example 1 was utilized.

### Comparative Example 2

A rechargeable lithium battery cell was manufactured in substantially the same manner as in Example 1 except that the additive of Synthesis Example 1 was not utilized.

### Comparative Example 3

A rechargeable lithium battery cell was manufactured in substantially the same manner as in Example 1 except that 0.5 wt % of aerogel was utilized instead of the additive of Synthesis Example 1.

### Comparative Example 4

A rechargeable lithium battery cell was manufactured in substantially the same manner as in Example 1 except that 2.0 wt % of aerogel was utilized instead of the additive of Synthesis Example 1.

### Evaluation 1: High temperature Cycle-life Evaluation

The rechargeable lithium battery cells of Example 1 and Comparative Examples 1, 3, and 4 were constant current-charged to a voltage of 4.4 V at a current rate of 0.5 C and subsequently, cut off at a current rate of 0.05 C in the constant voltage mode of 4.4 V at 45° C. Subsequently, the cells were constant current-discharged to a voltage of 3.0 V at the current rate of 0.5 C. The process was repeated 100 times. As a result of this charge and discharge experiment, capacity retention at the 100^{th} cycle was calculated according to Calculation Equation 1, and the results are shown in Table 1.

$${100}^{th} cycle capacity retention rate [ \% ] = [ \text{} {100}^{th} cycle discharge capacity / {1}^{st} cycle discharge capacity ] \times 100 \qquad Calculation Equation 1$$

TABLE 1

| | High temperature cycle-life |
|---|---|
| | (45° C., 100 cycle) (%) |
| Example 1 | 89.5 |
| Comparative Example 1 | 85.6 |
| Comparative Example 3 | 88.1 |
| Comparative Example 4 | 82.1 |

Referring to Table 1, the rechargeable lithium battery cell of Example 1 exhibited relatively excellent or suitable high temperature cycle-life characteristics of 89% at the 100^{th} cycle. The rechargeable lithium battery cell of Example 1 exhibited excellent or suitable high temperature cycle-life characteristics compared with the rechargeable lithium battery cells of Comparative Examples 1, 3, and 4.

### Evaluation 2: Thermal Exposure Evaluation

The rechargeable lithium battery cells of Example 1 and Comparative Examples 2 to 4 were evaluated with respect to thermal exposure after charging at 0.5 C/4.4 V 0.05 C cut-off (i.e., after charging at a constant current rate of 0.5 C until reaching 4.4 V, and then subsequently cutting off at a current rate of 0.05 C in the constant voltage mode of 4.4 V).

After placing the rechargeable lithium battery cells of Example 1 and Comparative Examples 2 to 4, respectively, in a chamber and increasing a temperature of the chamber from room temperature to 136° C. at 5±2° C./min, while maintaining the temperature for 1 hour or so, changes in the rechargeable lithium battery cells were examined. The thermal exposure above was performed twice, and the results are shown in Table 2.

TABLE 2

| | Thermal exposure temperature | | | | | | | |
|---|---|---|---|---|---|---|---|---|
| | 130° C. | | 132° C. | | 134° C. | | 136° C. | |
| | once | twice | once | Twice | once | twice | once | twice |
| Example 1 | | | | | | | OK | OK |
| Comparative | NG | OK | NG | NG | NG | NG | — | — |
| Example 2 | | | | | | | | |
| Comparative | — | — | NG | OK | NG | NG | — | — |
| Example 3 | | | | | | | | |
| Comparative | — | — | — | — | OK | OK | OK | OK |
| Example 4 | | | | | | | | |

In Table 2, the “NG” means that thermal runaway was observed at the thermal exposure temperature, and the “OK” means that there was no thermal runaway at the thermal exposure temperature.

The rechargeable lithium battery cells of Comparative Examples 2 to 3 exhibited thermal runaway when exposed to a high temperature, but the rechargeable lithium battery cells of the examples exhibited no thermal runaway due to the aerogel of the core materials, when exposed to a high temperature. Accordingly, the rechargeable lithium battery cells of the examples exhibited excellent or suitable battery safety, compared with the rechargeable lithium battery cells of the comparative examples.

Summarizing the evaluation results, because the rechargeable lithium battery cell of Comparative Example 2 included no aerogel, thermal runaway was observed. Because the rechargeable lithium battery cell of Comparative Example 3 had no core-shell structure, inferior high temperature cycle-life characteristics and also thermal runaway due to the use of a small amount of the aerogel were observed. The rechargeable lithium battery cell of Comparative Example 4 included sufficient aerogels and thus exhibited no thermal runaway but had no core-shell structure and exhibited inferior high temperature cycle-life characteristics. In contrast, the rechargeable lithium battery cells of the examples exhibited excellent or suitable high temperature cycle-life characteristics and concurrently (e.g., simultaneously), no thermal runaway on the thermal exposure, but instead maintained battery characteristics and concurrently (e.g., simultaneously), exhibited improved battery safety.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the singular forms “a,” “an” and “the” are intended to include the plural forms as well, unless the context clearly indicates otherwise.

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### Reference Numerals

100: rechargeable lithium battery
112: negative electrode
113: separator
114: positive electrode
120: battery case
140: sealing member

What is claimed is:

1. An additive for a rechargeable lithium battery, the additive comprising:
a core comprising an aerogel, and
a shell around the core,
wherein the shell comprises a polymer having a melting point of about 90 to about 120° C.

2. The additive of claim 1, wherein a thickness ratio of the core to the shell is about 1:1 to about 4:1.

3. The additive of claim 1, wherein the core has a thickness of about 0.1 μm to about 2.0 μm, and the shell has a thickness of about 0.025 μm to about 0.5 μm.

4. The additive of claim 1, wherein the core has a density of about 0.002 g/cm³ to about 0.03 g/cm³.

5. The additive of claim 1, wherein the aerogel is an inorganic oxide aerogel, a carbon aerogel, or a combination thereof.

6. The additive of claim 1, wherein the aerogel has a monolithic, block, sheet, powder, fiber, or granular shape.

7. The additive of claim 1, wherein the polymer comprises poly (vinylidenefluoride-hexafluoropropylene) (PVDF-HFP), polyacrylic acid, polyethylene, poly (methyl methacrylate), poly (alkylene oxide), poly (alkylene succinate), or a combination thereof.

8. The additive of claim 1, wherein the additive has a form of an electrospun fiber.

9. The additive of claim 1, wherein the additive has an ionic conductivity of about 1.0×10⁻⁴ S·cm⁻¹ to about 1.0×10⁻² S·cm⁻¹.

10. An electrolyte for a rechargeable lithium battery, the electrolyte comprising:
a non-aqueous organic solvent,
a lithium salt, and
the additive according to claim 1.

11. The electrolyte of claim 10, wherein the additive is about 0.1 wt % to about 20 wt % based on a total weight of the electrolyte for the rechargeable lithium battery.

12. The electrolyte of claim 10, wherein
the additive is about 0.1 wt % to about 15 wt % based on a total weight of the electrolyte for the rechargeable lithium battery.

13. The electrolyte of claim 10, wherein
the additive is about 0.1 wt % to about 10 wt % based on a total weight of the electrolyte for the rechargeable lithium battery.

14. A rechargeable lithium battery, comprising:
a positive electrode comprising a positive electrode active material;
a negative electrode comprising a negative electrode active material; and
the electrolyte according to claim 10.
